(19) United States
(12) Patent Application Publication
(10) Pub. No.: US 2016/0374078 A1
(43) Pub. Date: Dec. 22, 2016

(54) VIRTUAL ACCESS POINT (VAP) AND METHOD FOR CHANNEL SELECTION

(71) Applicants: Chittabrata Ghosh, Fremont, CA (US); Yaron Alpert, Hod Hasharoni (IL); Alex Pisarevski, Haifa (IL)

(72) Inventors: Chittabrata Ghosh, Fremont, CA (US); Yaron Alpert, Hod Hasharoni (IL); Alex Pisarevski, Haifa (IL)

(21) Appl. No.: 14/957,772

(22) Filed: Dec. 3, 2015

Related U.S. Application Data
(60) Provisional application No. 62/181,973, filed on Jun. 19, 2015.

(51) Int. Cl. H04W 72/04

(52) U.S. Cl. CPC H04W 72/0446; H04W 72/042

(57) ABSTRACT

Embodiments of a virtual access point (VAP) and method for channel selection in a wireless network are generally described herein. The VAP may determine, from a group of channels available for VAP usage, a primary channel for the VAP based at least partly on a determination of whether the channels of the group are used as primary channels by one or more other VAPs. The VAP may transmit a downlink signal to a station (STA) in VAP channel resources that include the determined primary channel and one or more secondary channels. The VAP may use a first encryption type and a first media access control (MAC) identifier while a second VAP may use a second encryption type and a second media access control (MAC) identifier. In some embodiments, multiple VAPs may be supported by a single access point (AP).

### PRIORITY CLAIM

This application claims priority under 35 USC 119(e) to U.S. Provisional Patent Application Ser. No. 62/181,973 filed Jun. 19, 2015 [reference number P86427Z (4884.296PRV)] which is incorporated herein by reference in its entirety.

### TECHNICAL FIELD

Embodiments pertain to wireless networks. Some embodiments relate to wireless local area networks (WLANs) and Wi-Fi networks including networks operating in accordance with the IEEE 802.11 family of standards, such as the IEEE 802.11REVmc standard or the IEEE 802.1 lax study group (SG) (named DensiFi and/or UniFi). Some embodiments relate to high-efficiency (HE) wireless or high-efficiency WLAN or Wi-Fi (HEW) communications. Some embodiments relate to virtual access points (VAPs), including co-located VAPs. Some embodiments relate to access points (APs) that may support multiple VAPs. Some embodiments relate to selection of channels for usage by a VAP, including primary channels and/or secondary channels.

### BACKGROUND

Wireless communications has been evolving toward ever increasing data rates (e.g., from IEEE 802.11a/g to IEEE 802.11n to IEEE 802.11ac). In high-density deployment situations, overall system efficiency may become more important than higher data rates. For example, in high-density hotspot and cellular offloading scenarios, many devices competing for the wireless medium may have low to moderate data rate requirements (with respect to the very high data rates of IEEE 802.11ac). A recently-formed study group for Wi-Fi evolution referred to as the IEEE 802.11 High Efficiency WLAN (HEW) study group (SG) (i.e., IEEE 802.11 ax) is addressing these high-density deployment scenarios.

### BRIEF DESCRIPTION OF THE DRAWINGS

FIG. 1 illustrates a wireless network in accordance with some embodiments;

FIG. 2 illustrates a station (STA) in accordance with some embodiments;

FIG. 3 illustrates an access point (AP) and a virtual access point (VAP) in accordance with some embodiments;

FIG. 4 illustrates the operation of a method of determination of channel resources in accordance with some embodiments;

FIG. 5 illustrates an example of selection of primary channels and secondary channels in accordance with some embodiments;

FIG. 6 illustrates another example of selection of primary channels and secondary channels in accordance with some embodiments;

FIG. 7 illustrates the operation of another method of determination of channel resources in accordance with some embodiments;

FIG. 8 illustrates a block diagram of an example machine in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

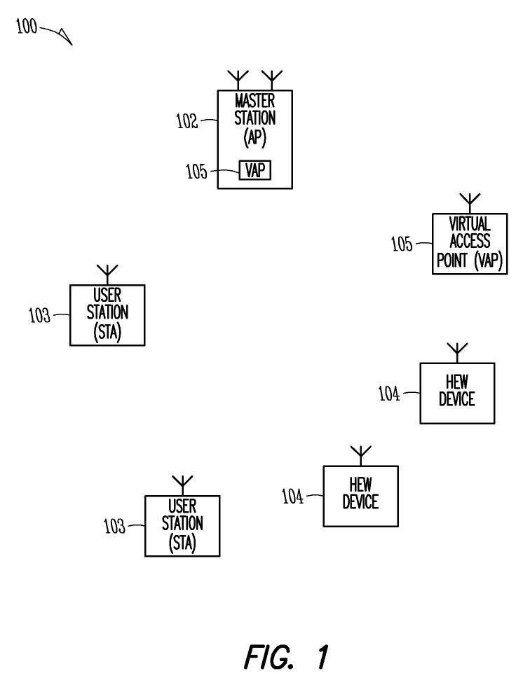

FIG. 1 illustrates a wireless network in accordance with some embodiments. In some embodiments, the network 100 may be a High Efficiency Wireless (HEW) Local Area Network (LAN) network. In some embodiments, the network 100 may be a Wireless Local Area Network (WLAN) or a Wi-Fi network. These embodiments are not limiting, however, as some embodiments of the network 100 may include a combination of such networks. That is, the network 100 may support HEW devices in some cases, non HEW devices in some cases, and a combination of HEW devices and non HEW devices in some cases. Accordingly, it is understood that although techniques described herein may refer to either a non HEW device or to an HEW device, such techniques may be applicable to both non HEW devices and HEW devices in some cases.

The network 100 may include one or more master stations (STA) 102, a plurality of stations (STAs) 103 and a plurality of HEW stations 104 (HEW devices). In some embodiments, one or more of the STAs 103 may be legacy stations. In some embodiments, one or more of the master STAs 102 may be legacy master stations. These embodiments are not limiting, however, as the STAs 103 may be HEW devices or may support HEW operation in some embodiments. The master station 102 may be arranged to communicate with the STAs 103 and/or the HEW stations 104 in accordance with one or more of the IEEE 802.11 standards. In accordance with some HEW embodiments, an access point (AP) may operate as the master station 102 and may be arranged to contend for a wireless medium (e.g., during a contention period) to receive exclusive control of the medium for an HEW control period (i.e., a transmission opportunity (TXOP)). The master station 102 may, for example, transmit a master-sync or control transmission at the beginning of the HEW control period to indicate, among other things, which one or more HEW stations 104 are scheduled for communication and/or simultaneous communication during the HEW control period. During the HEW control period, the scheduled HEW stations 104 may communicate with the master station 102 in accordance with a non-contention based multiple access technique. In some cases, non-contention based multiple access may be or may include scheduled multiple access. This is unlike conventional Wi-Fi communications in which devices simultaneously communicate in accordance with a contention-based communication technique, rather than a non-contention based multiple access technique. In such conventional Wi-Fi communications, reverse direction, polling and/or scheduled access may be used. In HEW communications, scheduled multiple access may be used in some cases. During the HEW control period, the master station 102 may communicate simultaneously with one or more HEW stations 104 using one or more HEW frames. During the HEW control period, STAs 103 not operating as HEW devices may refrain from communicating in some cases. In some embodiments, the master-sync transmission may be referred to as a control and schedule transmission and/or a coordinated transmission.

As will be described below, the AP 102 may be configured to support one or more virtual access points (VAPs) 105, although embodiments are not limited to support of VAPs 105 by the AP 102. As an example, one or more components of the AP 102, such as common MAC components, common physical layer components, common RF components or other, may be used as part of supporting the VAP 105. In some embodiments, a VAP 105 may support some or all functionality of the AP 102, such as communication with STAs 103. As an example, multiple VAPs 105 may be supported by the AP 102 and may communicate with STAs 103 in a transparent manner in which the STAs 103 may not necessarily be aware of the usage of VAPs 105 by the AP 102. That is, STAs 103 may communicate with the VAPs 105 as if they were separate APs 102. In addition, the STAs 103 may not necessarily be aware that the VAPs 105 are co-located and/or integrated at the same device, in some cases.

In some embodiments, encryption used for different VAPs 105 may be different in terms of type, algorithm used, initialization seeds and/or other parameters. In some embodiments, some VAPs may communicate according to different capabilities, transmission parameters and/or connectivity restrictions. In some embodiments, different VAPs 105 may use different media access control (MAC) protocol layer identifiers, such as Basic Service Set Identifier (BSSID), Service Set Identifier (SSID), MAC address or other identifiers. For instance, packets exchanged with different VAPs 105 may include such identifiers in a header. In some embodiments, the AP 102 may be segmented into multiple base station entities (VAPs 105) that may support unique wireless network services within a single radio frequency (RF) footprint of a single physical AP 102. In some embodiments, different VAPs 105 may operate according to different authentication settings. For instance, one VAP 105 may be open while another VAP 105 may require authentication. In some embodiments, VAPs 105 may be configured to forward traffic amongst themselves which may enable a network operator to segment a wireless network into separate, unconnected networks. In some embodiments, different VAPs 105 may be allocated or may support different bandwidths and/or throughputs.

In some embodiments, one or more stand-alone VAPs 105 may be included in the network 100 as shown in FIG. 1, in addition to or instead of the VAPs 105 supported by the AP 102. Accordingly, reference herein to a VAP 105 may be applicable to stand-alone VAPs 105 and/or VAPs 105 supported by the AP 102 in some cases. These embodiments are not limiting, however, as some embodiments may not necessarily include stand-alone VAPs 105.

It should be noted that discussion regarding functionality of the AP 102, such as functionality related to HEW operation and/or non-HEW operation, may be applicable to the VAP 105 in some cases. As an example, signals may be transmitted by the AP 102 and received from STAs 103 as part of HEW operation. When one or more VAPs 105 are supported by the AP 102, each VAP 105 may exchange those signals (or similar signals) with STAs 103 supported by the VAP 105.

In some embodiments, the VAP 105 supported by the AP 102 may transmit a downlink signal to a STA 103 in dedicated VAP channel resources that include a primary channel and one or more secondary channels. In some cases, the dedicated VAP channel resources may include one or more resource units (RUs) and/or a subset of RUs. The VAP 105 may also receive one or more uplink signals from the STA 103 in the VAP channel resources. These embodiments will be described in more detail below.

In some embodiments, the multiple-access technique used during the HEW control period may be a scheduled orthogonal frequency division multiple access (OFDMA) technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique including a multi-user (MU) multiple-input multiple-output (MIMO) (MU-MIMO) technique. These multiple-access techniques used during the HEW control period may be configured for uplink or downlink data communications.

The master station 102 may also communicate with STAs 103 and/or other legacy stations in accordance with legacy IEEE 802.11 communication techniques. In some embodiments, the master station 102 may also be configurable to communicate with the HEW stations 104 outside the HEW control period in accordance with legacy IEEE 802.11 communication techniques, although this is not a requirement.

In some embodiments, the HEW communications during the control period may be configurable to use one of 20 MHz, 40 MHz, or 80 MHz contiguous bandwidths or an 80+80 MHz (160 MHz) non-contiguous bandwidth. In some embodiments, a 320 MHz channel width may be used. In some embodiments, subchannel bandwidths less than 20 MHz may also be used. In these embodiments, each channel or subchannel of an HEW communication may be configured for transmitting a number of spatial streams.

In accordance with embodiments, a master station 102 and/or HEW stations 104 may generate an HEW packet in accordance with a short preamble format or a long preamble format. The HEW packet may comprise a legacy signal field (L-SIG) followed by one or more high-efficiency (HE) signal fields (HE-SIG) and an HE long-training field (HE-LTF). For the short preamble format, the fields may be configured for shorter-delay spread channels. For the long preamble format, the fields may be configured for longer-delay spread channels. These embodiments are described in more detail below. It should be noted that the terms “HEW” and “HE” may be used interchangeably and both terms may refer to high-efficiency Wireless Local Area Network operation and/or high-efficiency Wi-Fi operation.

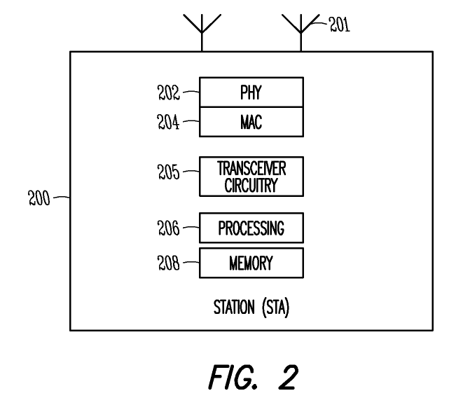

FIG. 2 illustrates a station (STA) in accordance with some embodiments. The STA 200 may be suitable for use as an STA 103 as depicted in FIG. 1, and may also be suitable for use as an HEW device 104 as shown in FIG. 1, such as an HEW station. The STA 200 may include physical layer circuitry 202 and a transceiver 205, one or both of which may enable transmission and reception of signals to and from APs, other STAs or other devices using one or more antennas 201. As an example, the physical layer circuitry 202 may perform various encoding and decoding functions that may include formation of baseband signals for transmission and decoding of received signals. As another example, the transceiver 205 may perform various transmission and reception functions such as conversion of signals between a baseband range and a Radio Frequency (RF) range. Accordingly, the physical layer circuitry 202 and the transceiver 205 may be separate components or may be part of a combined component. In addition, some of the described functionality related to transmission and reception of signals may be performed by a combination that may include one, any or all of the physical layer circuitry 202, the transceiver 205, and other components or layers. The STA 200 may also include medium access control layer (MAC) circuitry 204 for controlling access to the wireless medium. The STA 200 may also include processing circuitry 206 and memory 208 arranged to perform the operations described herein.

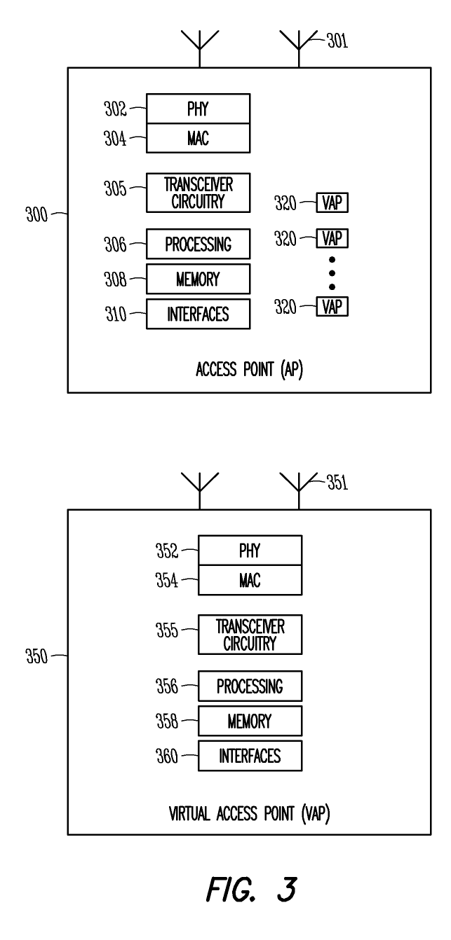

FIG. 3 illustrates an access point (AP) and a virtual access point (VAP) in accordance with some embodiments. The AP 300 may be suitable for use as an AP 102 as depicted in FIG. 1. It should be noted that in some embodiments, the AP 300 may be a stationary non-mobile device. The AP 300 may include physical layer circuitry 302 and a transceiver 305, one or both of which may enable transmission and reception for transmission and reception of signals to and from the STA 200, other APs, other STAs or other devices using one or more antennas 301. The physical layer circuitry 302 and the transceiver 305 may perform various functions similar to those described regarding the STA 200 previously. Accordingly, the physical layer circuitry 302 and the transceiver 305 may be separate components or may be part of a combined component. In addition, some of the described functionality related to transmission and reception of signals may be performed by a combination that may include one, any or all of the physical layer circuitry 302, the transceiver 305, and other components or layers.

The AP 300 may also include medium access control layer (MAC) circuitry 304 for controlling access to the wireless medium. The AP 300 may also include processing circuitry 306 and memory 308 arranged to perform the operations described herein. The AP 300 may also include one or more interfaces 310, which may enable communication with other components, including other APs 102 (FIG. 1). In addition, the interfaces 310 may enable communication with other components that may not be shown in FIG. 1, including components external to the network 100. The interfaces 310 may be wired or wireless or a combination thereof.

In some embodiments, the AP 300 may also be configured to support one or more VAPs 320. The VAPs 320 (which may be suitable for use as a VAP 105 as in FIG. 1) may be configured to perform one or more operations using components of the AP 300 described previously, such as the PHY 302, MAC 304, transceiver circuitry 305, processing 306, memory 308, and interfaces 310. As an example, the PHY 302 may perform physical layer operations for one or more VAPs 320 while the MAC 304 may perform MAC operations for the VAPs 320.

In some embodiments, one or more of the VAPs 320 may include components that may be separate from similar components included in the AP 300 to perform operations previously described. The VAP 350 (which may be suitable for use as a VAP 105 as in FIG. 1) may include any or all of PHY 352, MAC 354, transceiver circuitry 355, processing 356, memory 358, interfaces 360, and antennas 351. As an example, the VAP 350 may be suitable for use as a VAP 320. As another example, the VAP 350 may be a stand-alone apparatus or device. As another example, operations may be performed by the VAP 320 using a combination of separate components and components included in the AP 300. In some embodiments, the VAP 350 may be a multi VAP 350 that may include one or more MAC modules.

The antennas 201, 301, 351 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 201, 301, 351 may be effectively separated to take advantage of spatial diversity and the different channel characteristics that may result.

In some embodiments, the STA 200, AP 300 or the VAP 350 may be a mobile device and may be a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a wearable device such as a medical device (e.g., a heart rate monitor, a blood pressure monitor, etc.), or other device that may receive and/or transmit information wirelessly. In some embodiments, the STA 200, AP 300 or VAP 350 may be configured to operate in accordance with 802.11 standards, although the scope of the embodiments is not limited in this respect. Mobile devices or other devices in some embodiments may be configured to operate according to other protocols or standards, including other IEEE standards, Third Generation Partnership Project (3GPP) standards or other standards. In some embodiments, the STA 200, AP 300, VAP 350 or other device may include one or more of a keyboard, a display, a non-volatile memory port, multiple antennas, a graphics processor, an application processor, speakers, and other mobile device elements. The display may be an LCD screen including a touch screen.

Although the STA 200, the AP 300, and the VAP 350 are each illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

It should be noted that in some embodiments, an apparatus used by the STA 200, AP 300 and/or VAP 350 may include various components of the STA 200, AP 300 and/or AP 350 as shown in FIGS. 2-3. Accordingly, techniques and operations described herein that refer to the STA 200 (or 103 or 104) may be applicable to an apparatus for an STA. In addition, techniques and operations described herein that refer to the AP 300 (or 102) may be applicable to an apparatus for an AP. In addition, techniques and operations described herein that refer to the VAP 350 may be applicable to an apparatus for a VAP.

In some embodiments, the STA 200 may be configured as an HEW device 104 (FIG. 1), and may communicate using OFDM communication signals over a multicarrier communication channel. Accordingly, in some cases the STA 200 may be configured to receive signals in accordance with specific communication standards, such as the Institute of Electrical and Electronics Engineers (IEEE) standards including IEEE 802.11-2012, 802.11n-2009, 802.11ac-2013 and/or 802.11revmc standards and/or proposed specifications for WLANs including proposed HEW standards, although the scope of the invention is not limited in this respect as they may also be suitable to transmit and/or receive communications in accordance with other techniques and standards. In some other embodiments, the STA 200 configured as an HEW device 104 may be configured to receive signals that were transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

Embodiments disclosed herein provide two preamble formats for High Efficiency (HE) Wireless LAN standards specification that is under development in the IEEE Task Group 11ax (TGax).

In accordance with embodiments, a VAP 105 may determine, from a group of channels available for VAP usage, a primary channel for the VAP 105 based at least partly on a determination of whether the channels of the group are used as primary channels by one or more other VAPs 105. The VAP 105 may transmit a downlink signal to an STA 103 in VAP channel resources that may include the determined primary channel and one or more secondary channels. The VAP 105 may use a first encryption type and a first media access control (MAC) identifier while a second VAP 105 may use a second encryption type and a second media access control (MAC) identifier. In some embodiments, multiple VAPs 105 may be supported by an access point AP 102. These embodiments will be described in more detail below.

In some embodiments, channel resources may be used for downlink transmission by the AP 102 and/or VAP 105 and may be used for uplink transmissions by the STAs 103. That is, a time-division duplex (TDD) format may be used. In some cases, the channel resources may include multiple channels, such as the 20 MHz channels previously described. The channels may include multiple sub-channels or may be divided into multiple sub-channels for the uplink transmissions to accommodate multiple access for multiple STAs 103. The downlink transmissions may or may not utilize the same format.

In some embodiments, the downlink sub-channels may comprise a predetermined bandwidth. As a non-limiting example, the sub-channels may each span 2.03125 MHz, the channel may span 20 MHz, and the channel may include eight or nine sub-channels. Although reference may be made to a sub-channel of 2.03125 MHz for illustrative purposes, embodiments are not limited to this example value, and any suitable frequency span for the sub-channels may be used. In some embodiments, the frequency span for the sub-channel may be based on a value included in an 802.11 standard (such as 802.1 lax), a 3GPP standard or other standard.

In some embodiments, the sub-channels may comprise multiple sub-carriers. Although not limited as such, the sub-carriers may be used for transmission and/or reception of OFDM or OFDMA signals. As an example, each sub-channel may include a group of contiguous sub-carriers spaced apart by a pre-determined sub-carrier spacing. As another example, each sub-channel may include a group of non-contiguous sub-carriers. That is, the channel may be divided into a set of contiguous sub-carriers spaced apart by the pre-determined sub-carrier spacing, and each sub-channel may include a distributed or interleaved subset of those sub-carriers. The sub-carrier spacing may take a value such as 78.125 kHz, 312.5 kHz or 15 kHz, although these example values are not limiting. Other suitable values that may or may not be part of an 802.11 or 3GPP standard or other standard may also be used in some cases. As an example, for a 78.125 kHz sub-carrier spacing, a sub-channel may comprise 26 contiguous sub-carriers or a bandwidth of 2.03125 MHz.

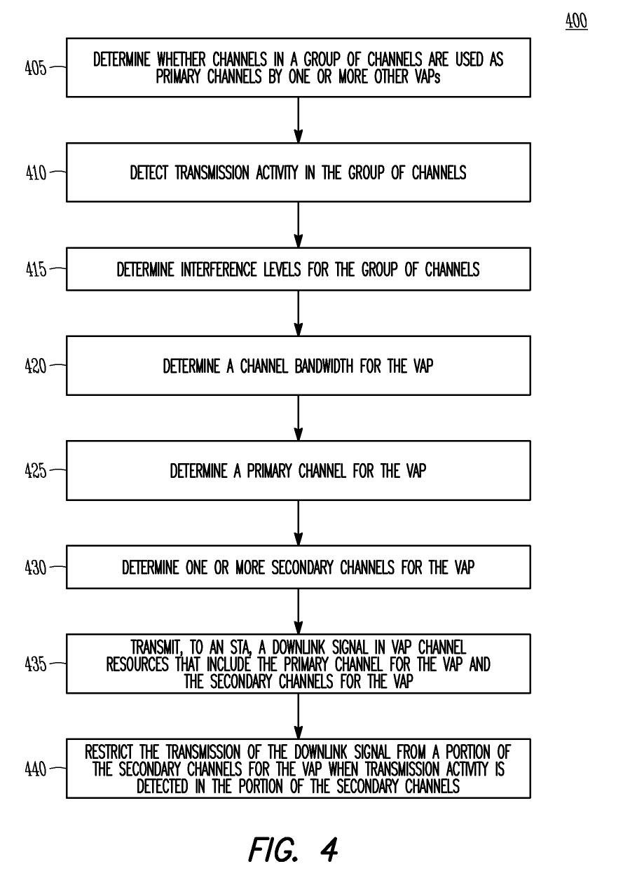

FIG. 4 illustrates the operation of a method of determination of channel resources in accordance with some embodiments. It is important to note that embodiments of the method 400 may include additional or even fewer operations or processes in comparison to what is illustrated in FIG. 4. In addition, embodiments of the method 400 are not necessarily limited to the chronological order that is shown in FIG. 4. In describing the method 400, reference may be made to FIGS. 1-3 and 5-6, although it is understood that the method 400 may be practiced with any other suitable systems, interfaces and components.

In addition, while the method 400 and other methods described herein may refer to STAs 103, VAPs 105 and APs 102 operating in accordance with 802.11 or other standards, embodiments of those methods are not limited to just those devices and may also be practiced on other mobile devices, such as an HEW STA, an HEW AP, an Evolved Node-B (eNB) or User Equipment (UE). In some embodiments, the STA 103 described in the method 400 may be an HEW STA 103. In some embodiments, the VAP 105 and/or the AP 102 may be an HEW AP 102. The method 400 and other methods described herein may also be practiced by wireless devices configured to operate in other suitable types of wireless communication systems, including systems configured to operate according to various Third Generation Partnership Project (3GPP) Long Term Evolution (LTE) standards. The method 400 may also refer to an apparatus for an STA 103 and/or VAP 105 and/or AP 102 or other device described above.

In addition, some or all of the techniques and/or operations described herein that may be applicable to VAPs 105 may also be applicable to co-located AP 102 (CL-AP) arrangements, in some cases.

At operation 405 of the method 400, the VAP 105 may detect and/or determine whether channels included in a group of channels are used as primary channels by one or more other VAPs. In some embodiments, the group of channels may be available for VAP usage. As an example, the group of channels may or may not be contiguous in frequency. As another example, the channels in the group may comprise any suitable bandwidth, such as 20 MHz, 40 MHz, 80 MHz or other bandwidth. As another example, the channels available for VAP usage may comprise a bandwidth of 20 MHz while the primary channels may also comprise a bandwidth of 20 MHz. As another example, the channels available for VAP usage may comprise a bandwidth of 20 MHz while the primary channels may comprise a bandwidth of 40 MHz or 80 MHz. Accordingly, in this example, the primary channel may comprise multiple channels in the group of channels available for VAP usage.

At operation 410, the VAP 105 may detect and/or determine transmission activity of the other VAPs 105 and/or one or more STAs 103 connected to the other VAPs 105. At operation 415, the VAP 105 may detect and/or determine interference levels for the group of channels. At operation 420, the VAP 105 may determine a channel bandwidth to be used by the VAP 105. As an example, a channel bandwidth used by another VAP 105 may be detected by the VAP 105, and the VAP 105 may use the detected channel bandwidth for its primary channels and secondary channels.

As part of operations 405-420, the VAP 105 may perform operations such as channel sensing, bandwidth sensing, spectrum analysis, signal energy detection, decoding of packets or others. In some embodiments, operations such as 405-420 and others may be performed when the AP 102 is configured to support multiple VAPs 105 and is configured to support open loop primary channel selection. Accordingly, the VAP 105 may select a primary channel for usage based on monitoring of activity of other VAPs 105 (and STAs 103 communicating with those VAPs 105) such as in operations 405-420. In some cases, the open loop selection may be un-coordinated selection. In some embodiments, any or all of operations such as 405-420 and/or others may be performed for all VAPs 105 together. In some embodiments, some of the VAPs 105 may share information between themselves as part of performing any or all of these and/or other operations. In some embodiments, the VAPs 105 may also decode information sent by other VAPs 105 such as resource allocations and other information. For instance, a trigger frame (TF) may be decoded in some cases.

In some embodiments, the AP 102 may be configured to support multiple VAPs 105 and to support closed loop primary channel selection. In some cases, the closed loop selection may be pre-coordinated selection. Accordingly, the AP 102 or other component (such as any of the VAPs 105) may act as a central coordinator to assign primary channels (and secondary channels in some cases) to the VAPs 105. The assignment may be communicated to the VAPs in one or more control messages, which may be dedicated messages, broadcast messages or other suitable type of message. It should be noted that embodiments are not limited to usage of a central coordinator to assign the channels to the VAPs 105. In some embodiments, one or more distributed coordinators may be used. For instance, the assignment functionality may be divided amongst multiple coordinators.

In some embodiments, the primary channel for the VAP 105 may be allocated and/or assigned, by the controller device, as a primary channel for at least one of the other VAPs 105, although the scope of embodiments is not limited in this respect. In some embodiments, the primary channel allocated to the VAP 105 may be allocated and/or assigned, by the controller device, as a primary channel for all of the VAPs 105. For instance, the primary channel in this case may be a common primary channel allocated and/or assigned as a primary channel for all the VAPs 105.

At operation 425, the VAP 105 may determine a primary channel for the VAP 105. In some embodiments, the determination may be based at least partly on one or more of operations 405-420. As an example, one or more resource units (RUs) may be determined and/or allocated for one or more VAPs 105. As an example, when the transmission activity is undetected in at least a portion of the group of channels available for VAP usage, the primary channel for the VAP 105 may be selected from the portion of the group of channels. That is, a channel that is determined as “unused” by the other VAPs 105 may be selected as the primary channel for the VAP 105. As another example, interference levels for the channels may also be determined, and the unused channel with minimum detected interference level may be selected as the primary channel for the VAP 105.

As another example, when transmission activity is detected in all the channels of the group of channels available for VAP usage, the primary channel for the VAP 105 may be selected based at least partly on the detected transmission activity. For instance, the channel for which the detected transmission activity is lowest may be selected as the primary channel for the VAP 105. As another example, the primary channel selected for the VAP 105 may at least partly overlap a primary channel used by a second VAP 105.

As another example, the primary channel for the VAP 105 may be selected based at least partly on one or more frequency differences between the primary channel and channels for which the transmission activity is detected. When the transmission activity is detected on one or more channels, the primary channel for the VAP 105 may be selected from a sub-group of channels in which the transmission activity is undetected or not detected. From the sub-group of channels, a primary channel may be selected to reduce or minimize adjacent channel interference (ACI). For instance, the VAP 105 may determine that a particular channel is already used as a primary channel by another VAP 105. A channel at maximum frequency difference from that particular channel may be selected by the VAP 105 as its primary channel in order to reduce or minimize ACI from that particular channel. When multiple channels are determined to be already in use as primary channels, the selection may be based on detected levels of transmission activity and/or detected signal levels. For instance, an unused channel at maximum frequency difference from the used channel with maximum detected signal level may be used as the primary channel for the VAP 105.

At operation 430, one or more secondary channels for the VAP 105 may be determined. In some embodiments, the secondary channels may be selected based at least partly on the selected primary channel for the VAP 105. As an example, a channel adjacent in frequency to the primary channel (either higher or lower in frequency) may be selected as a secondary channel. Additional secondary channels may be selected in a similar manner in some cases. For instance, two or more channels above or below the selected primary channel in frequency may be used as secondary channels. In some embodiments, the secondary channels may use the same bandwidth as the primary channel, although the scope of embodiments is not limited in this respect. As an example, this flow of operations described for selection of the secondary channels may be performed at a powering up of the VAP 105. As another example, the flow of operations may be repeated based on any suitable criteria and/or feedback.

In some cases, the secondary channel(s) may be used as a primary channel by one or more other VAPs 105. For instance, as part of the selection of a primary channel for the VAP 105, primary channels of other VAPs 105 may be determined. One or more of those primary channels of the other VAPs 105 may be adjacent to the selected primary channel for the VAP 105, in some cases. Therefore, one or more of the secondary channels determined for the VAP 105 may already be in usage as a primary channel by the other VAPs 105.

At operation 435, the VAP 105 may transmit a downlink signal to the STA 103 in VAP channel resources. At operation 440, the VAP 105 may restrict the transmission from a portion of secondary channels included in the VAP channel resources. In some embodiments, the VAP channel resources may include the determined primary channel for the VAP 105. The VAP channel resources may further include one or more secondary channels in some embodiments. As an example, the secondary channels may be adjacent to the determined primary channel for the VAP 105.

In some embodiments, the VAP 105 may transmit the downlink signal in at least a portion of the VAP channel resources. As an example, at least the primary channel may be used for the transmission of the downlink signal. As another example, the primary channel and the secondary channels may be used for the transmission of the downlink signal. As another example, the transmission of the downlink signal may be restricted from a portion of the secondary channels when the VAP 105 determines transmission activity in the portion of the secondary channels. In some cases, the transmission activity may be performed by or related to other VAPs 105 or by one or more STAs 103 connected to the other VAPs 105. In this example, the primary channel and the portion of the secondary channels may be used for the transmission of the downlink signal.

In addition, the VAP 105 may receive uplink signals from one or more STAs 103 in the VAP channel resources. The STA 103 may use similar techniques to determine whether to use the secondary channels, although embodiments are not limited as such. In some embodiments, the VAP 105 may transmit one or more control messages to inform STAs 103 of the VAP channel resources. Such control messages may be dedicated control messages, broadcast control messages or other suitable control messages.

In some embodiments, a first encryption type for the VAP 105 may be different from a second encryption type for a second VAP 105 supported by the AP 102. In some embodiments, a first media access control (MAC) identifier for the first VAP 105 may be different from a second MAC identifier for a second VAP 105 supported by the AP 102.

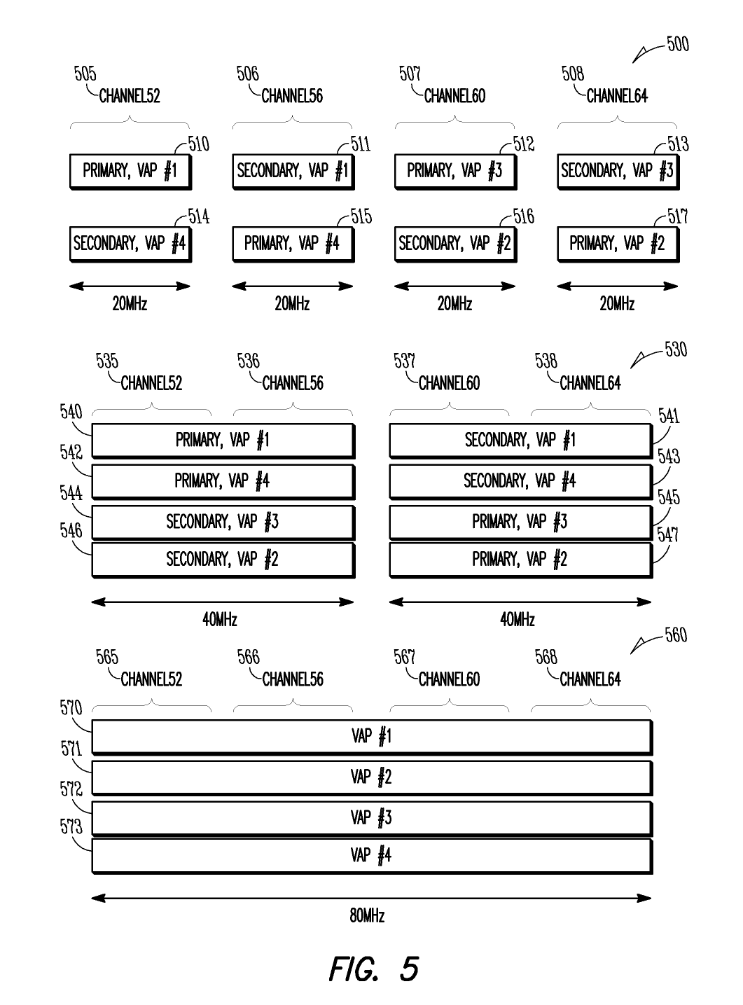

FIG. 5 illustrates an example of selection of primary channels and secondary channels in accordance with some embodiments. It should be noted that the scenarios 500, 530, 560 shown in FIG. 5 may serve to illustrate some or all of the concepts and techniques described herein, but embodiments are not limited to those example scenarios. For instance, embodiments are not limited to the number of channels, the bandwidths, the number of VAPs 105, or any other aspects shown in FIG. 5. Embodiments are also not limited to the ordering or arrangement of channels as shown in FIG. 5.

In the example scenarios 500, 530, and 560, four VAPs 105 (denoted as #1-#4) may select primary and secondary channels using an open loop selection technique. Accordingly, the VAPs 105 may also select the operating channel bandwidth. The available channels for VAP usage, 52, 56, 60, and 64 (numbered 505-508) may each comprise a 20 MHz bandwidth. The channels 505-508 may be adjacent in frequency, although embodiments are not limited as such. As will be described below, the primary channel may comprise a bandwidth of 20 MHz in scenario 500, 40 MHz in scenario 530, and 80 MHz in scenario 560.

In the example scenario 500, VAP #1 may select channel 52 as its primary channel 510 and may select channel 56 as its secondary channel 511. Subsequently, VAP #2 may select channel 64 as its primary channel 517 and may select channel 60 as its secondary channel 516. The selection of channel 64 as the primary channel may be based on a determination that channel 52 is already in use as a primary channel (for VAP #1) and therefore channels 56, 60, and 64 may be available for selection. Of the available channels, channel 64 is located further away from channel 52 in frequency than are the other available channels 56 and 60, and may therefore be selected as the primary channel 517 for VAP #2. In addition, VAP #2 may detect that the primary channel 510 used by VAP #1 comprises 20 MHz, and may use the same 20 MHz bandwidth for its primary channel 517 and secondary channel 516. VAP #3 may select channel 60 as its primary channel 512 based on the unavailability of channels 52 and 64 (due to primary channel usage by VAP #1 and VAP #2). VAP #3 may also select channel 64 as its secondary channel 513. VAP #4 may select channel 56 as its primary channel 515 based on the unavailability of channels 52, 60, and 64 (due to primary channel usage by VAP #1, VAP #2, and VAP #3), and may select channel 52 as its secondary channel 514. It should be noted that the primary and secondary channels in the example scenario 500 are non-overlapping.

In the example scenario 530, VAP #1 may select channels 52 and 56 for usage as a 40 MHz primary channel 540, and may select channels 60 and 64 for usage as a 40 MHz secondary channel 541. Subsequently, VAP #2 may select channels 60 and 64 for usage as a primary channel 547 based on a determination of primary channel usage of channels 52 and 56 by VAP #1. In addition, the 40 MHz bandwidth of primary channel 540 may be determined and may be used as the bandwidth of the primary channel 547 by VAP #2. VAP #2 may also select channels 52 and 56 as a secondary channel 546. VAP #3 may determine primary channel usage of all the available channels 52, 56, 60 and 64, and may therefore select channels 60 and 64 as a primary channel although those channels are already used by other VAPs for primary channels. In some cases, the selection of channels 60 and 64 (as opposed to channels 52 and 56) may be based on a detected interference level, detected transmission activity level or other factor. VAP #3 may also select channels 52 and 56 as a secondary channel 544. VAP #4 may also determine primary channel usage of all the available channels 52, 56, 60 and 64, and may select channels 52 and 56 as a primary channel 542 although those channels are already used by other VAPs for primary channels. In some cases, the selection of channels 52 and 56 (as opposed to channels 60 and 64) may be based on a detected interference level, detected transmission activity level or other factor. For instance, primary channel usage by both VAP #2 and VAP #3 in channels 60 and 64 may be considered as part of the selection. VAP #4 may also select channels 60 and 64 as a secondary channel 543. It should be noted that the primary and secondary channels in the example scenario 530 are non-overlapping.

In the example scenario 560, VAP #1 may select channels 52, 56, 60, and 64 for usage as an 80 MHz primary channel 570. Subsequently, VAP #2 may determine the 80 MHz bandwidth, and may also select the same channels 52, 56, 60, and 64 for usage as an 80 MHz primary channel 571. In a similar manner, VAP #3 may select the same channels for usage as an 80 MHz primary channel 572 and VAP #4 may select the same channels for usage as an 80 MHz primary channel 573. It should be noted that in the example scenario 560, secondary channels may not be used.

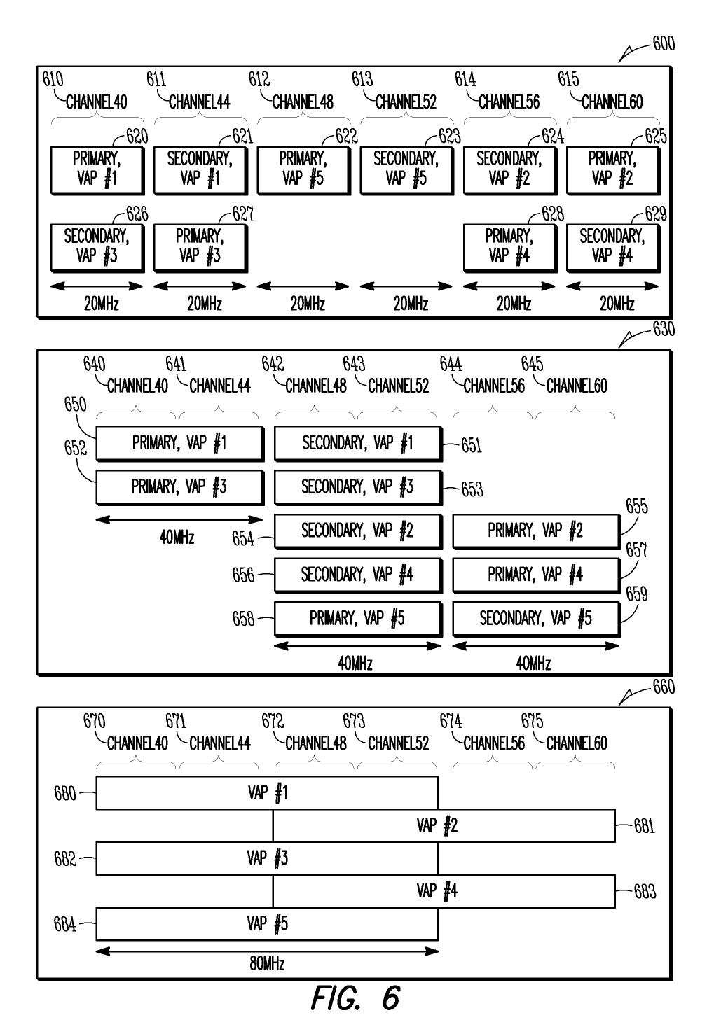

FIG. 6 illustrates another example of selection of primary channels and secondary channels in accordance with some embodiments. It should be noted that the scenarios 600, 630, 660 shown in FIG. 6 may serve to illustrate some or all of the concepts and techniques described herein, but embodiments are not limited to those example scenarios. For instance, embodiments are not limited to the number of channels, the bandwidths, the number of VAPs 105, or any other aspects shown in FIG. 5. Embodiments are also not limited to the ordering or arrangement of channels as shown in FIG. 5.

In the example scenarios 600, 630, and 660, five VAPs 105 (denoted as #1-#4) may select primary and secondary channels using an open loop selection technique. Accordingly, the VAPs 105 may also select the operating channel bandwidth. The available channels for VAP usage, 40, 44, 48, 52, 56, and 60 (numbered 610-615) may each comprise a 20 MHz bandwidth. The channels 610-615 may be adjacent in frequency, although embodiments are not limited as such. As will be described below, the primary channel may comprise a bandwidth of 20 MHz in scenario 600, 40 MHz in scenario 630, and 80 MHz in scenario 660.

In the example scenario 600, VAP #1 may select channel 40 as its primary channel 620 and may select channel 44 as its secondary channel 621. Subsequently, VAP #2 may select channel 60 as its primary channel 625 and may select channel 56 as its secondary channel 624. The selection of channel 60 as the primary channel may be based on a determination that channel 40 is already in use as a primary channel (for VAP #1) and therefore channels 44, 48, 52, 56, and 60 may be available for selection. Of the available channels, channel 60 is located further away from channel 40 in frequency than are the other available channels 44, 48, 52, and 56, and may therefore be selected as the primary channel 625 for VAP #2. In addition, VAP #2 may detect that the primary channel 620 used by VAP #1 comprises 20 MHz, and may use the same 20 MHz bandwidth for its primary channel 625 and secondary channel 624. VAP#3, VAP #4, and VAP #5 may select primary channels and secondary channels using similar techniques.

In the example scenario 630, VAP #1 may select channels 40 and 44 for usage as a 40 MHz primary channel 650 and may select channels 48 and 52 for usage as a 40 MHz secondary channel 651. Subsequently, VAP #2 may select channels 56 and 60 for usage as a 40 MHz primary channel 655 and may select channels 48 and 52 for usage as a 40 MHz secondary channel 654. In addition, VAP #2 may detect that the primary channel 650 used by VAP #1 comprises 40 MHz, and may use the same 40 MHz bandwidth for its primary channel 655 and secondary channel 654. VAP #3, VAP #4, and VAP #5 may select primary channels and secondary channels using similar techniques.

In the example scenario 660, VAP #1 may select channels 40, 44, 48, and 52 for usage as an 80 MHz primary channel 680. VAP #2 may select channels 48, 52, 56, and 60 for usage as an 80 MHz primary channel 681. It should be noted that the primary channel 681 for VAP #2 partly overlaps the primary channel 680 for VAP #1. The selection of the channels 48-60 may be based on a determination of primary usage of channels 40-52 and may be selected to reduce or minimize overlap. Accordingly, channels 56 and 60 may be unused (or determined as unused) and may be included, along with used channels 48 and 52, in the primary channel 681. In addition, VAP #2 may detect that the primary channel 680 used by VAP #1 comprises 80 MHz, and may use the same 80 MHz bandwidth for its primary channel 681. VAP #3, VAP #4, and VAP #5 may select primary channels using similar techniques. It should be noted that in the example scenario 560, secondary channels may not be used.

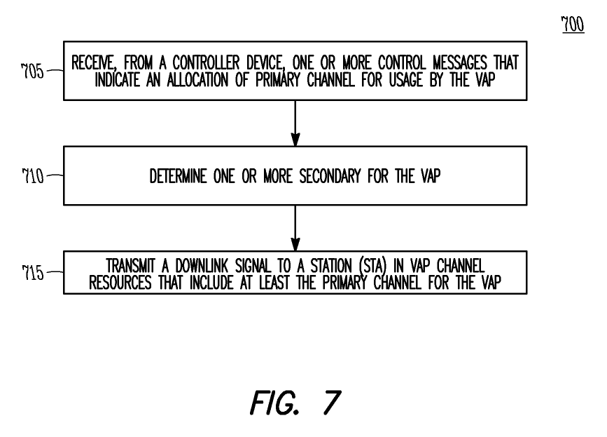

FIG. 7 illustrates the operation of another method of determination of channel resources in accordance with some embodiments. It is important to note that embodiments of the method 700 may include additional or even fewer operations or processes in comparison to what is illustrated in FIG. 7. In addition, embodiments of the method 700 are not necessarily limited to the chronological order that is shown in FIG. 7. In describing the method 700, reference may be made to FIGS. 1-6, although it is understood that the method 700 may be practiced with any other suitable systems, interfaces and components.

In addition, while the method 700 and other methods described herein may refer to STAs 103, VAPs 105 and APs 102 operating in accordance with 802.11 or other standards, embodiments of those methods are not limited to just those devices and may also be practiced on other mobile devices, such as an HEW STA, an HEW AP, an Evolved Node-B (eNB) or User Equipment (UE). In some embodiments, the STA 103 described in the method 700 may be an HEW STA 103. In some embodiments, the VAP 105 and/or the AP 102 may be an HEW AP 102. The method 700 and other methods described herein may also be practiced by wireless devices configured to operate in other suitable types of wireless communication systems, including systems configured to operate according to various Third Generation Partnership Project (3GPP) Long Term Evolution (LTE) standards. The method 700 may also refer to an apparatus for an STA 103 and/or VAP 105 and/or AP 102 or other device described above. In addition, some or all of the techniques and/or operations described herein that may be applicable to VAPs 105 may also be applicable to co-located AP 102 (CL-AP) arrangements, in some cases.

It should also be noted that some or all aspects of concepts described herein may be applicable to the method 700 in some cases, including VAPs, primary channels, secondary channels and/or others.

At operation 705, the VAP 105 may receive, from a controller device, one or more control messages that indicate an allocation of a primary channel for usage by the VAP 105. In some embodiments, the control messages may further indicate a bandwidth of the primary channel and/or a bandwidth to be used by the VAP 105. As a non-limiting example, the primary channel may be included in system channel resources that are allocated, by the controller device, to the VAP 105 and to one or more other VAPs 105. Accordingly, the controller device may be responsible, in some cases, for allocation of the primary channel and/or other channels to the VAP 105 and the other VAPs 105. As an example, the one or more control messages may include one or more capability advertising messages.

In some embodiments, the VAP 105 may be configured to communicate with the STA 103 as an AP instantiation. As an example, the VAP 105 may be configured to communicate with the STA 103 according to a service set identifier (SSID) that is different from SSIDs used by the other VAPs 105 for communication with one or more other STAs 103. As another example, the VAP 105 may be configured to communicate with the STA 103 using a media access control (MAC) address that is different from a MAC address used by the other VAPs 105 for communication with one or more other STAs 103. As another example, the VAP 105 may be configured to communicate with the STA 103 using an identifier of the VAP that is different from identifiers of the other VAPs 105.

In some embodiments, the VAP 105 and the other VAPs 105 may be configured to use different encryption, in some cases, in terms of type, technique, initialization and/or other aspect. In some embodiments, the VAP 105 and the other VAPs 105 may be configured to exchange data using different formats in terms of modulation, data rate, forward error correction (FEC) and/or other aspects. It should be noted that some or all aspects of the VAP 105 as described regarding the method 700 may be applicable, in some cases, to the method 400 and/or other embodiments.

In some embodiments, the primary channel for the VAP 105 may be allocated, by the controller device, as a primary channel for at least one of the other VAPs 105, although the scope of embodiments is not limited in this respect. In some embodiments, the primary channel allocated to the VAP 105 may be allocated, by the controller device, as a primary channel for all of the VAPs 105. For instance, the primary channel in this case may be a common primary channel allocated as a primary channel for all the VAPs 105.

In some embodiments, the controller device may be an access point (AP) 102, although these embodiments are not limiting. In some embodiments, the VAP 105 may be included as part of the AP 102. Accordingly, the AP 102 may support multiple VAPs 105 in a manner in which STAs 103 communicating with the VAPs 105 may communicate as if the VAPs 105 were APs 102.

At operation 710, the VAP 105 may determine one or more secondary channels to be included in the VAP channel resources. As an example, the secondary channels may be adjacent to the determined primary channel for the VAP 105, although embodiments are not limited as such. It should be noted that some embodiments may not necessarily include operation 710. That is, the VAP channel resources may not necessarily include secondary channels in some cases.

At operation 715, the VAP 105 may transmit a downlink signal to an STA 103 in the VAP channel resources. As described previously, the VAP channel resources may include at least the primary channel. The VAP channel resources may or may not include secondary channels. In addition, the VAP 105 may receive one or more uplink signals from one or more STAs 103 in the VAP channel resources in some cases.

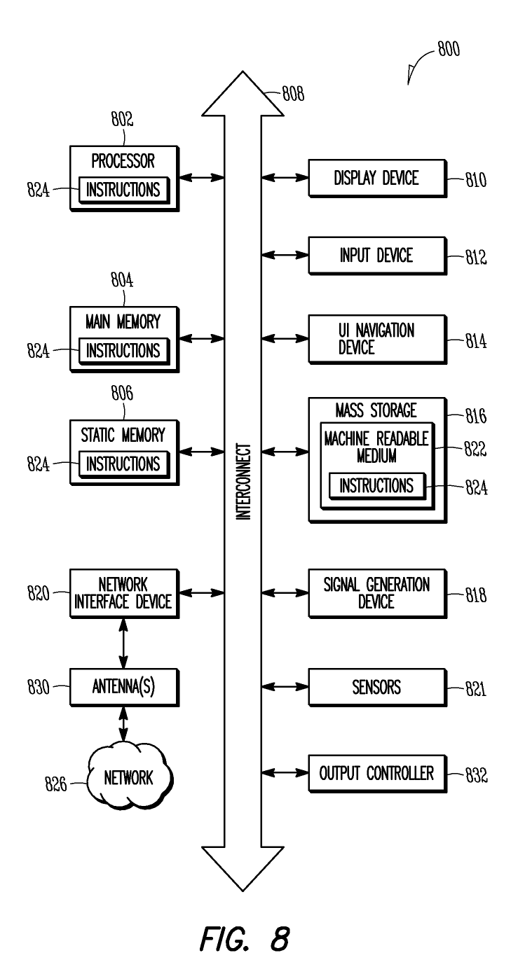

FIG. 8 illustrates a block diagram of an example machine in accordance with some embodiments. The machine 800 is an example machine upon which any one or more of the techniques and/or methodologies discussed herein may be performed. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a UE 102, eNB 104, access point (AP), station (STA), mobile device, base station, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. It should be noted that in some embodiments, an AP or other base station may include some or all of the components shown in either FIG. 3 or FIG. 8 or both. It should be noted that in some embodiments, a station (STA) or other mobile device may include some or all of the components shown in either FIG. 2 or FIG. 8 or both. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media. In some embodiments, the machine readable medium may be or may include a non-transitory computer-readable storage medium.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; and/or a flash memory.

While the machine readable medium 822 is illustrated as a single medium, the term “machine readable medium” may include a single medium or multiple media (e.g., a centralized or distributed database, and/or associated caches and servers) configured to store the one or more instructions 824. The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. In some examples, the network interface device 820 may wirelessly communicate using Multiple User MIMO techniques. The term “transmission medium” shall be taken to include any intangible medium that is capable of storing, encoding or carrying instructions for execution by the machine 800, and includes digital or analog communications signals or other intangible medium to facilitate communication of such software.

An example of an apparatus for a virtual access point (VAP) is disclosed herein. The apparatus may comprise hardware processing circuitry and transceiver circuitry. The hardware processing circuitry may be configured to determine, from a group of channels available for VAP usage, a primary channel for the VAP based at least partly on a determination of whether the channels of the group are used as primary channels by one or more other VAPs. The hardware processing circuitry may configure the transceiver circuitry to transmit a downlink signal to a station (STA) in VAP channel resources that include the determined primary channel for the VAP and further include one or more secondary channels adjacent to the determined primary channel for the VAP.

In some examples, at least one of the secondary channels included in the VAP channel resources may be determined as a primary channel for at least one of the other VAPs. In some examples, the primary channel included in the VAP channel resources may at least partly overlap a primary channel included in second VAP channel resources used by a second VAP. In some examples, the determination of the primary channel usage of the group of channels by the other VAPs may include a detection, in the group of channels, of transmission activity of the other VAPs or one or more STAs connected to the other VAPs. In some examples, a bandwidth for the primary channel for the VAP may be selected based at least partly on a determined bandwidth for the transmission activity of the other VAPs or the STAs connected to the other VAPs.

In some examples, when the transmission activity is undetected in at least a portion of the group of channels, the primary channel for the VAP may be selected from the portion of the group of channels. In some examples, the primary channel may be selected based at least partly on one or more frequency differences between the primary channel for the VAP and channels for which the transmission activity is detected. In some examples, the primary channel for the VAP may be selected based at least partly on the detected transmission activity in the group of channels. The detected transmission activity level for the selected primary channel for the VAP may not be greater than the detected transmission activity levels of the other channels in the group of channels. In some examples, the transmission of the downlink signal may be performed in at least the primary channel of the VAP channel resources. The transmission of the downlink signal may be restricted from a portion of the secondary channels in the VAP channel resources when transmission activity by the other VAPs or by one or more STAs connected to the other VAPs is determined in the portion of the secondary channels.

In some examples, the apparatus may be further for an access point (AP) configured to support multiple VAPs in the group of channels. In some examples, the primary channel for the VAP may be determined based on the primary channel usage by the other VAPs when the AP is configured to support open loop primary channel selection. The hardware processing circuitry may be further configured to, when the AP is configured to support closed loop primary channel selection, determine the primary channel for the VAP based at least partly on one or more control messages received from the AP. In some examples, a first encryption type for the VAP may be different from a second encryption type for a second VAP supported by the AP. In some examples, a first media access control (MAC) identifier for the first VAP may be different from a second MAC identifier for a second VAP supported by the AP. In some examples, the VAP may be arranged to operate according to a wireless local area network (WLAN) protocol. The channels may comprise a predetermined bandwidth selected from a group that includes 20 MHz, 40 MHz, and 80 MHz. In some examples, the apparatus may further comprise one or more antennas coupled to the transceiver circuitry for the transmission of the downlink signal.

An example of a non-transitory computer-readable storage medium that contains instructions, which when executed by one or more processors result in performing operations that may configure a VAP to detect whether channels of a group of channels are used as primary channels by one or more other VAPs. The operations may further configure the VAP to detect interference levels for the group of channels and select, from the group of channels, a primary channel for the VAP. When the primary channel usage by the other VAPs is undetected for the group of channels, the primary channel for the VAP may be selected according to a minimum detected interference level for the group of channels. When the primary channel usage by the other VAPs is detected for one or more channels in the group of channels, the primary channel for the VAP may be selected according to frequency differences between the primary channel for the VAP and the channels for which the primary channel usage by the other VAPs is detected.

In some examples, a bandwidth for the primary channel for the VAP may be selected based at least partly on a determined bandwidth for the primary channel usage by the other VAPs. In some examples, the operations may further configure the VAP to transmit a downlink signal to a station (STA) in VAP channel resources that include the primary channel for the VAP and one or more secondary channels for the VAP. In some examples, the VAP may be a first VAP. Primary channel usage by a second VAP of at least one of the secondary channels for the first VAP may be detected by the first VAP. In some examples, the operations may further configure the VAP to detect, in the secondary channels for the VAP, transmission activity of other VAPs or STAs connected to the other VAPs. The transmission of the downlink signal may be performed in at least the primary channel for the VAP. The transmission of the downlink signal may be restricted from secondary channels for the VAP in which the transmission activity is detected. In some examples, the group of channels may be available for usage by multiple VAPs. A first media access control (MAC) identifier for the VAP may be different from a second MAC identifier for a second VAP operating in the group of channels.

An example of a method of channel selection performed at a virtual access point (VAP) is also disclosed herein. The method may comprise determining, from a group of channels available for VAP usage, a primary channel for the VAP based at least partly on a determination of whether the channels in the group are used as primary channels by one or more other VAPs. The method may further comprising transmitting a downlink signal to a station (STA) in VAP channel resources that include the determined primary channel for the VAP and further include one or more secondary channels adjacent to the determined primary channel for the VAP. In some examples, the method may further comprise detecting, in the group of channels, transmission activity of the other VAPs or one or more STAs connected to the other VAPs. When the transmission activity is undetected in at least a portion of the group of channels, the primary channel for the VAP may be selected from the portion of the group of channels.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus for a virtual access point (VAP), the apparatus comprising hardware processing circuitry and transceiver circuitry, the hardware processing circuitry configured to:
determine, from a group of channels available for VAP usage, a primary channel for the VAP based at least partly on a determination of whether the channels of the group are used as primary channels by one or more other VAPs; and
configure the transceiver circuitry to transmit a downlink signal to a station (STA) in VAP channel resources that include the determined primary channel for the VAP and further include one or more secondary channels adjacent to the determined primary channel for the VAP.

2. The apparatus according to claim 1, wherein at least one of the secondary channels included in the VAP channel resources is determined as a primary channel for at least one of the other VAPs.

3. The apparatus according to claim 1, wherein the primary channel included in the VAP channel resources at least partly overlaps a primary channel included in second VAP channel resources used by a second VAP.

4. The apparatus according to claim 1, wherein the determination of the primary channel usage of the group of channels by the other VAPs includes a detection, in the group of channels, of transmission activity of the other VAPs or one or more STAs connected to the other VAPs.

5. The apparatus according to claim 4, wherein a bandwidth for the primary channel for the VAP is selected based at least partly on a determined bandwidth for the transmission activity of the other VAPs or the STAs connected to the other VAPs.

6. The apparatus according to claim 4, wherein when the transmission activity is undetected in at least a portion of the group of channels, the primary channel for the VAP is selected from the portion of the group of channels.

7. The apparatus according to claim 4, wherein the primary channel for the VAP is selected based at least partly on one or more frequency differences between the primary channel for the VAP and channels for which the transmission activity is detected.

8. The apparatus according to claim 4, wherein the primary channel for the VAP is selected based at least partly on the detected transmission activity in the group of channels, and
the detected transmission activity level for the selected primary channel for the VAP is not greater than the detected transmission activity levels of the other channels in the group of channels.

9. The apparatus according to claim 1, wherein:
the transmission of the downlink signal is performed in at least the primary channel of the VAP channel resources, and
the transmission of the downlink signal is restricted from a portion of the secondary channels in the VAP channel resources when transmission activity by the other VAPs or by one or more STAs connected to the other VAPs is determined in the portion of the secondary channels.

10. The apparatus according to claim 1, wherein the apparatus is further for an access point (AP) configured to support multiple VAPs in the group of channels.

11. The apparatus according to claim 10, wherein the determination of the primary channel for the VAP is based at least partly on one or more control messages received from the AP, wherein the control messages indicate the primary channel for the VAP.

12. The apparatus according to claim 11, wherein the primary channel for the VAP is allocated, by the AP, as a primary channel for at least one of the other VAPs.

13. The apparatus according to claim 11, wherein the primary channel for the VAP is allocated, by the AP, as a common primary channel for the VAP and for all of the other VAPs.

14. The apparatus according to claim 10, wherein the primary channel for the VAP is determined based on the primary channel usage by the other VAPs when the AP is configured to support open loop primary channel selection, and
the hardware processing circuitry is further configured to, when the AP is configured to support closed loop primary channel selection, determine the primary channel for the VAP based at least partly on one or more control messages received from the AP.

15. The apparatus according to claim 10, wherein a first encryption type for the VAP is different from a second encryption type for a second VAP supported by the AP.

16. The apparatus according to claim 10, wherein a first media access control (MAC) identifier for the first VAP is different from a second MAC identifier for a second VAP supported by the AP.

17. The apparatus according to claim 1, wherein:
the VAP is arranged to operate according to a wireless local area network (WLAN) protocol, and
the channels comprise a predetermined bandwidth selected from a group that includes 20 MHz, 40 MHz, and 80 MHz.

18. The apparatus according to claim 1, the apparatus further comprising one or more antennas coupled to the transceiver circuitry for the transmission of the downlink signal.

19. A non-transitory computer-readable storage medium that contains instructions, which when executed by one or more processors result in performing operations to configure a virtual access point (VAP) to:
detect whether channels of a group of channels are used as primary channels by one or more other VAPs;
detect interference levels for the group of channels; and
select, from the group of channels, a primary channel for the VAP,
wherein when usage of a channel in the group as a primary channel by one or more of the other VAPs is undetected for the group of channels, the primary channel for the VAP is selected according to a minimum detected interference level for the group of channels, and
wherein when usage of a channel in the group as a primary channel by one or more of the other VAPs is detected for one or more channels in the group of channels, the primary channel for the VAP is selected according to frequency differences between the primary channel for the VAP and the channels for which the primary channel usage by the other VAPs is detected.

20. The non-transitory computer-readable storage medium according to claim 19, wherein a bandwidth for the primary channel for the VAP is selected based at least partly on a determined bandwidth for the primary channel usage by the other VAPs.

21. The non-transitory computer-readable storage medium according to claim 19, wherein the operations further configure the VAP to transmit a downlink signal to a station (STA) in VAP channel resources that include the primary channel for the VAP and one or more secondary channels for the VAP.

22. The non-transitory computer-readable storage medium according to claim 21, wherein:
the VAP is a first VAP, and
primary channel usage by a second VAP of at least one of the secondary channels for the first VAP is detected by the first VAP.

23. The non-transitory computer-readable storage medium according to claim 21, wherein:
the operations further configure the VAP to detect, in the secondary channels for the VAP, transmission activity of other VAPs or STAs connected to the other VAPs,
the transmission of the downlink signal is performed in at least the primary channel for the VAP,
the transmission of the downlink signal is restricted from secondary channels for the VAP in which the transmission activity is detected.

24. The non-transitory computer-readable storage medium according to claim 19, wherein:
the group of channels are available for usage by multiple VAPs, and
a first media access control (MAC) identifier for the VAP is different from a second MAC identifier for a second VAP operating in the group of channels.

25. A method of channel selection performed at a virtual access point (VAP), the method comprising:
determining, from a group of channels available for VAP usage, a primary channel for the VAP based at least partly on a determination of whether the channels in the group are used as primary channels by one or more other VAPs; and
transmitting a downlink signal to a station (STA) in VAP channel resources that include the determined primary channel for the VAP and further include one or more secondary channels adjacent to the determined primary channel for the VAP.

26. The method according to claim 25, wherein:
the method further comprises detecting, in the group of channels, transmission activity of the other VAPs or one or more STAs connected to the other VAPs, and
when the transmission activity is undetected in at least a portion of the group of channels, the primary channel for the VAP is selected from the portion of the group of channels.

27. An apparatus for a virtual access point (VAP), the apparatus comprising hardware processing circuitry and transceiver circuitry, the hardware processing circuitry to configure the transceiver circuitry to:
receive, from a controller device, one or more control messages that indicate an allocation of a primary channel for usage by the VAP; and
transmit a downlink signal to a station (STA) in VAP channel resources that include the primary channel for the VAP and further include one or more secondary channels adjacent to the determined primary channel for the VAP,
wherein the VAP channel resources are included in system channel resources that are allocated, by the controller device, to the VAP and to one or more other VAPs.

28. The apparatus according to claim 27, wherein:
the VAP is configured to communicate with the STA as an access point (AP) instantiation, and
the VAP is configured to communicate with the STA according to a service set identifier (SSID) that is different from SSIDs used by the other VAPs for communication with one or more other STAs.

29. The apparatus according to claim 27, wherein the primary channel for the VAP is allocated, by the controller device, as a primary channel for at least one of the other VAPs.

30. The apparatus according to claim 27, wherein the primary channel for the VAP is allocated, by the controller device, as a common primary channel for the VAP and for all of the other VAPs.

31. The apparatus according to claim 27, wherein the control messages further indicate a bandwidth of the primary channel.

32. The apparatus according to claim 27, wherein the controller device is an access point (AP).

33. The apparatus according to claim 32, wherein the apparatus for the VAP is included as part of the AP.
